(19) United States
(12) Patent Application Publication
(10) Pub. No.: US 2025/0309517 A1
(43) Pub. Date: Oct. 2, 2025

(54) SECTOR FRAME ANTENNA MOUNT ASSEMBLIES

(71) Applicant: Outdoor Wireless Networks LLC, Richardson, TX (US)

(72) Inventor: Jared D. Haines, Rock City Falls, NY (US)

(21) Appl. No.: 19/052,543

(22) Filed: Feb. 13, 2025

Related U.S. Application Data
(60) Provisional application No. 63/573,098, filed on Apr. 2, 2024.

(51) Int. Cl. H01Q 1/12

(52) U.S. Cl. CPC H01Q 1/1228

(57) ABSTRACT

The present application is directed to a sector frame antenna mount assembly. The assembly includes a mast and bracket support. The mast and bracket support includes a horizontal member and a plurality of mounting brackets secured along a length of the horizontal member. The assembly further includes a plurality of vertical members. Each vertical member is secured to a respective mounting bracket of the mast and bracket support and configured to have at least one antenna mounted thereon. The plurality of mounting brackets provide fixed mounting locations along a length of the horizontal member for the corresponding vertical members such that optimal antenna performance may be achieved when antennas are mounted to each vertical member.

### CROSS-REFERENCE TO RELATED APPLICATION

The present application claims priority to and the benefit of U.S. Provisional Patent Application No. 63/573,098, filed on Apr. 2, 2024, the disclosure of which is incorporated herein by reference in its entirety.

### FIELD

The present invention relates to telecommunications equipment, and more particular, a mast and bracket support for mounting vertical pipes on an antenna sector frame assembly.

### BACKGROUND

With increased demand for more wireless communication, the number of radio and antenna units that a tower traditionally supports has increased and is expected to continue to increase. New towers will need to be designed to support greater numbers of antenna and radio units, while existing towers are retrofitted to support more units, and effort is made to fully utilize space available on the towers.

An exemplary sector frame antenna mount assembly 10 is illustrated in FIGS. 1A-1B. The sector frame antenna mount assembly 10 includes a sector frame 20 for antenna mounting and an offset mount 30. The sector frame 20 includes horizontal members (e.g., pipes) 22 and vertical members (e.g., pipes) 24 which allow the mounting of antennas (not shown) thereon. The offset mount 30 is configured to be secured to the horizontal members 22 of the sector frame 20 (e.g., via mounting brackets or other fasteners 35) and may be used to position and secure the sector frame 20 (and antennas mounted thereon) a distance from a mounting structure (not shown). The sector frame 20 may also include one or more tie-back pipes 12 secured to the horizontal members 22 (via mounting brackets or other fasteners 15). See also, e.g., U.S. Pat. No. 9,812,762 to Skrepcinski et al.; U.S. Pat. No. 9,853,346 to Skrepcinski et al.; and U.S. Pat. No. 10,122,064 to Skrepcinski et al., the disclosures of which are hereby incorporated herein in full.

The vertical members 24 are secured to the horizontal members 22 (via mounting brackets or other fasteners 25) and are spaced apart along the length of the horizontal members 22 at least a minimum distance from each other to help mitigate or eliminate interference between the antennas. There may be a need for an assembly that provides defined spacing between the vertical members for optical antenna performance.

### SUMMARY

A first aspect of the present invention is directed to a sector frame antenna mount assembly. The assembly includes a mast and bracket support. The mast and bracket support includes a horizontal member and a plurality of mounting brackets secured along a length of the horizontal member. The assembly further includes a plurality of vertical members. Each vertical member is secured to a respective mounting bracket of the mast and bracket support and configured to have at least one antenna mounted thereon. The plurality of mounting brackets provide fixed mounting locations along a length of the horizontal member for the corresponding vertical members such that optimal antenna performance may be achieved when antennas are mounted to each vertical member.

Another aspect of the present invention is directed to a sector frame antenna mount assembly. The assembly includes a mast and bracket support. The mast and bracket support includes a horizontal member, a first mounting bracket, a second mounting bracket, and a third mounting bracket. The first, second and third mounting brackets are secured along a length of the horizontal member. The assembly further includes three vertical members. Each vertical member is secured to a respective mounting bracket and configured to have at least one antenna mounted thereon. The first mounting bracket is positioned at a center point along the length of the horizontal member. The second and third mounting brackets are positioned a distance in opposite directions from the center point. The distance that the second and third mounting brackets are positioned from the center point is about 60 inches.

Another aspect of the present invention is directed to a sector frame antenna mount assembly. The assembly includes a mast and bracket support. The mast and bracket support includes a horizontal member, a first mounting bracket, a second mounting bracket, a third mounting bracket, and a fourth mounting bracket. The first, second, third and fourth mounting brackets are secured along a length of the horizontal member. The assembly further includes four vertical members. Each vertical member is secured to a respective mounting bracket and configured to have at least one antenna mounted thereon. The first and second mounting brackets are positioned a first distance in opposite directions from a center point along the length of the horizontal member. The third and the fourth mounting brackets are positioned a second distance in opposite directions from the center point. The first distance that the first and second mounting brackets are positioned from the center point is about 24 inches, and the second distance that the third and fourth mounting brackets are positioned from the center point is about 72 inches.

Another aspect of the present invention is directed to a sector frame antenna mount assembly. The assembly includes a mast and bracket support. The mast and bracket support includes a horizontal member, a first mounting bracket, a second mounting bracket, a third mounting bracket, a fourth mounting bracket, and a fifth mounting bracket. The first, second, third, fourth, and fifth mounting brackets are secured along a length of the horizontal member. The assembly further includes five vertical members. Each vertical member is secured to a respective mounting bracket and configured to have at least one antenna mounted thereon. The first mounting bracket is positioned at a center point along the length of the horizontal member. The second and third mounting brackets are positioned a first distance in opposite directions from the center point. The fourth and fifth mounting brackets are positioned a second distance in opposite directions from the center point. The first distance that the second and third mounting brackets are positioned from the center point is about 28 inches, and the second distance that the fourth and fifth mounting brackets are positioned from the center point is about 84 inches.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1A is a perspective view of a known sector frame antenna mount assembly.

FIG. 1B is a front view of the sector frame antenna mount assembly of FIG. 1A.

FIG. 2A is a front perspective view of a sector frame antenna mount assembly according to embodiments of the present invention in which the sector frame antenna mount assembly includes a mast and bracket support according to embodiments of the present invention.

FIG. 2B is a front view of the sector frame antenna mount assembly of FIG. 2A.

FIG. 3A is a front view of the mast and bracket support according to embodiments of the present invention.

FIG. 3B is a front perspective view of the mast and bracket support of FIG. 3A.

FIG. 3C is an enlarged view of a section of the mast and bracket support of FIG. 3B.

FIG. 4A is a front perspective view of a bracket for the mast and bracket support of FIG. 3A according to embodiments of the present invention.

FIG. 4B is a rear perspective view of the bracket of FIG. 4A.

FIGS. 5A-5C illustrate spacing of three mounting brackets (FIG. 5A), four mounting brackets (FIG. 5B), and five mounting brackets (FIG. 5C) on the mast and bracket support which allows for optical antenna performance according to embodiments of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components, or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer, or section. Thus, a first element, component, region, layer, or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

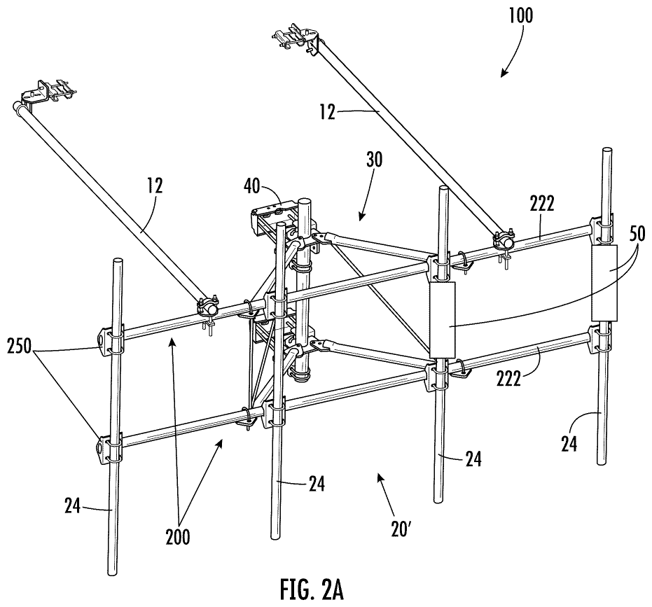

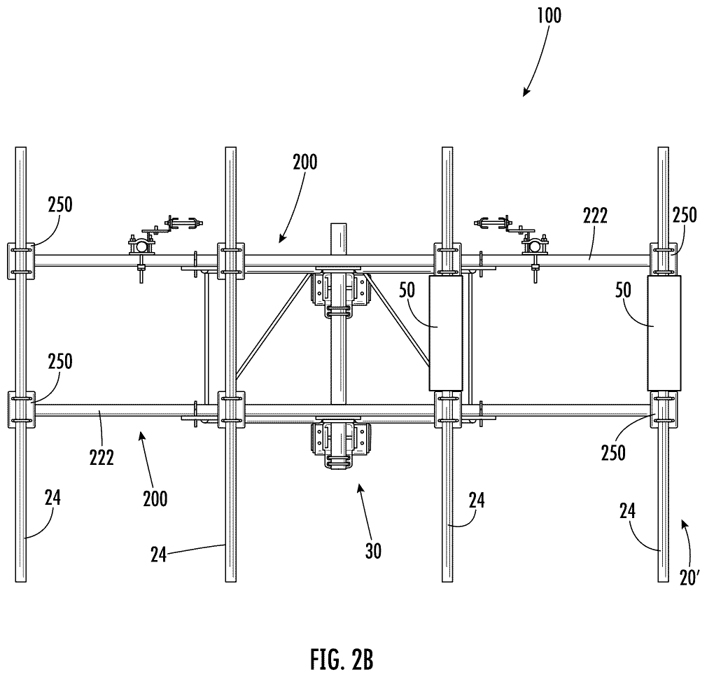

Embodiments of the present invention are directed to a sector frame antenna mount assembly. The sector frame antenna mount assembly includes at least one mast and bracket support. The mast and bracket support replaces respective horizontal pipes of a known sector frame antenna mount assembly and provides fixed mounting locations for the corresponding vertical pipes of the sector frame. The fixed locations are spaced apart along a length of the mast such that optimal antenna performance may be achieved by the one or more antennas mounted to each vertical pipe. Embodiments of the present invention will now be described in further detail below with reference to FIGS. 2A-5C.

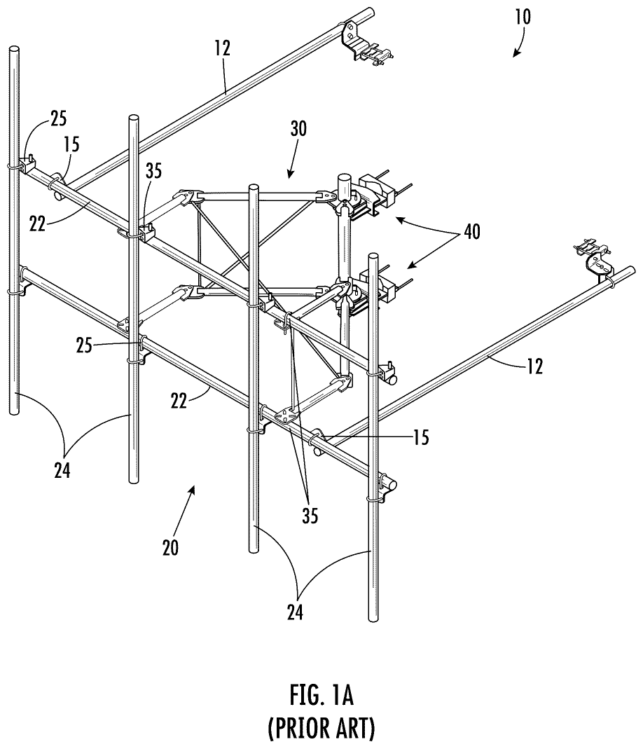

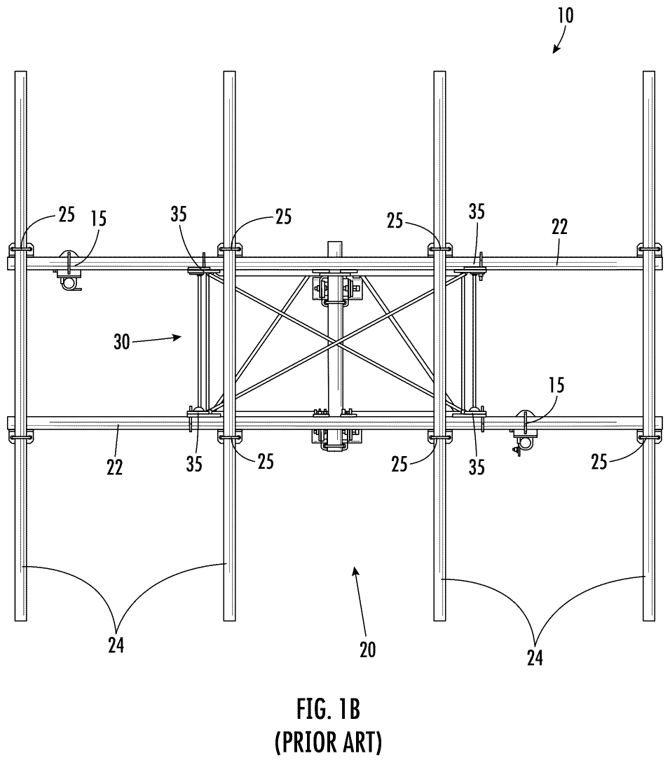

Referring to FIGS. 2A-2B, a sector frame antenna mount assembly 100 according to embodiments of the present invention. The sector frame antenna mount assembly 100 is similar to the sector frame antenna mount assembly 10 described above and shown in FIGS. 1A-1B. As shown in FIGS. 2A-2B, in some embodiments, the second frame antenna mount assembly 100 of the present invention includes a sector frame 20′ for antenna mounting.

As further shown in FIGS. 2A-2B, the sector frame antenna mount assembly 100 of the present invention differs from the sector frame antenna mount assembly 10 in that the sector frame antenna mount assembly 100 includes one or more mast and bracket supports 200. Each of the mast and bracket supports 200 replace a respective horizontal member 22 of the sector frame 20. As described in further detail below, the mast and bracket supports 200 are configured to engage one or more vertical members 24. The mast and bracket supports 200 and the vertical members 24 together form the sector frame 20′ of the sector frame antenna mount assembly 100.

In some embodiments, an offset mount 30 is configured to be secured to the mast and bracket support 200 of the sector frame 20′ (e.g., via mounting brackets or other fasteners 35 like shown in FIGS. 1A-1B) and may be used to position and secure the sector frame 20′ (and antennas mounted thereon) a distance from a mounting structure (not shown). Similar to the sector frame 20, the sector frame 20′ of the present invention may also include one or more tie-back pipes 12 secured to the mast and bracket support 200 (via mounting brackets or other fasteners 15).

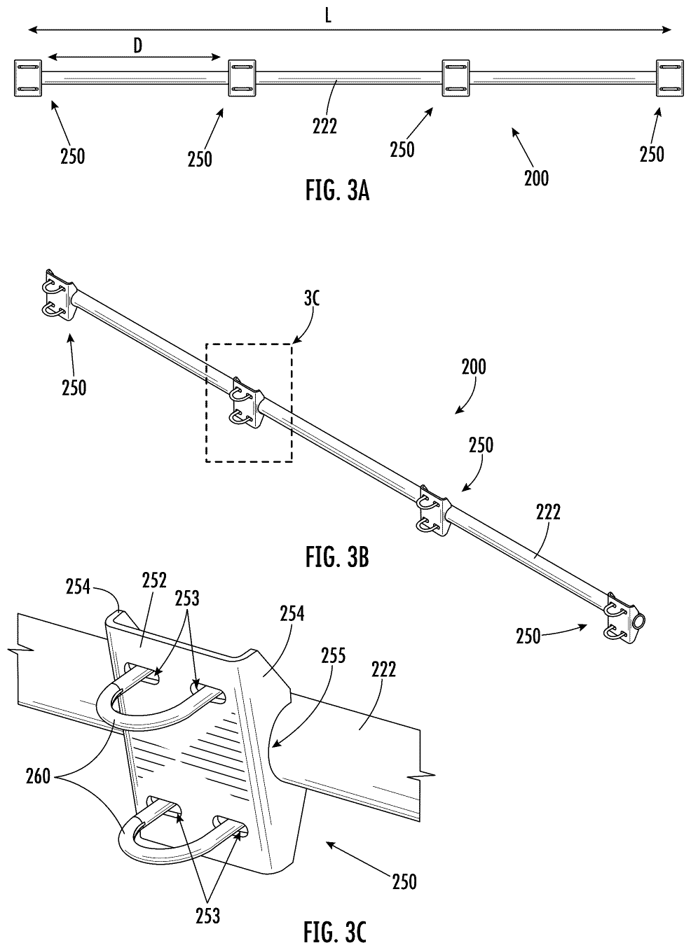

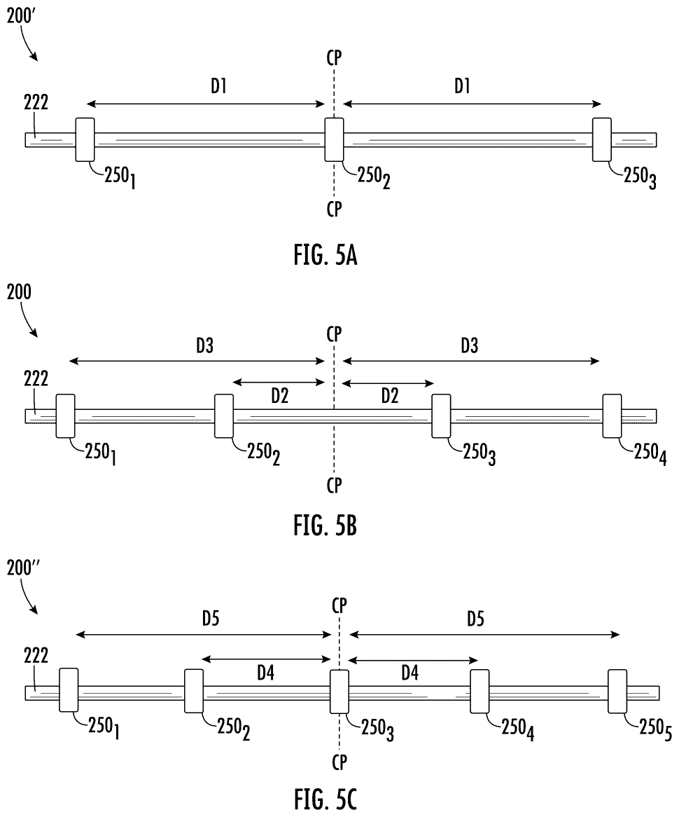

Referring to FIGS. 3A-3C, a mast and bracket support 200 according to embodiments of the present invention is illustrated. In some embodiments, the mast and bracket support 200 comprises a horizontal member (or pipe) 222 and a plurality of mounting brackets 250. In some embodiments, the mast and bracket support 200 includes three, four, or five mounting brackets 250₁₋₅ (see, e.g., FIGS. 5A-5C). The mounting brackets 250 are secured to the horizontal member 222. For example, in some embodiments, the mounting brackets 250 are welded to the horizontal member 222. As shown in FIG. 3A, the horizontal member 222 has a length L and the mounting brackets 250 are spaced apart a distance D from each other along the length L of the horizontal member 222.

As shown in FIG. 3C, each mounting bracket 250 is configured to engage and secure a respective vertical member 24 to the horizontal member 222. The horizontal member 222 and the vertical members 24 together form the sector frame 20′. The distance D between each mounting bracket 250 (and distance D1-D5 from a center point CP of the horizontal member 222, see, e.g., FIGS. 5A-5C) allows for optimal antenna performance to be achieved by the one or more antennas 50 mounted on each respective vertical members 24. In other words, the antennas 50 are positioned a sufficient distance D from each other to avoid interference with each other (see, e.g. FIGS. 2A-2B).

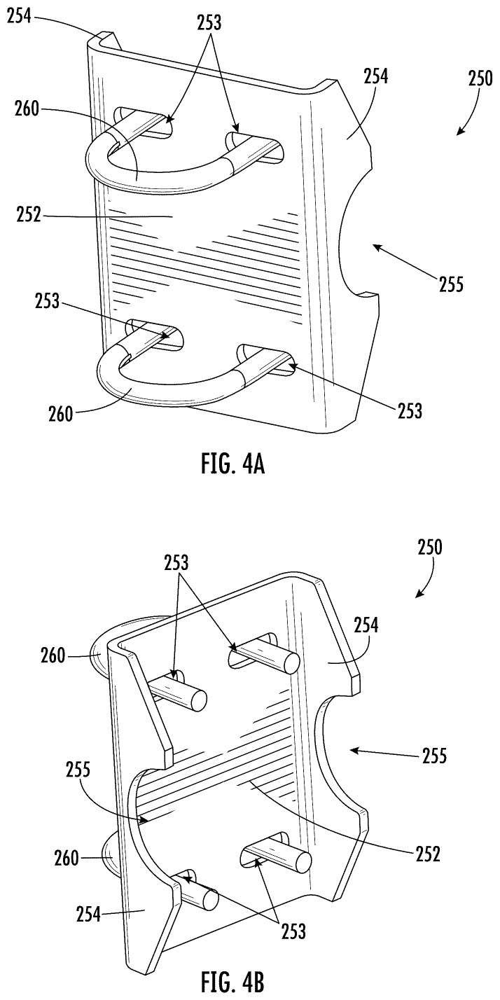

Referring to FIGS. 4A-4B, a mounting bracket 250 of the mast and bracket support 200 according to embodiments of the present invention is illustrated. As shown in FIGS. 4A-4B, in some embodiments, the mounting bracket 250 comprises a main plate 252 having opposing side walls 254 extending outwardly therefrom. The main plate 252 has a plurality of apertures 253 configured to receive a fastener 260. The fastener(s) 260 are configured to secure a respective vertical member 24 of the sector frame 20′ to the mounting bracket 250 (and horizontal member 222) (see, e.g., FIG. 3C). For example, in some embodiments, the fastener 260 is a U-bolt. In some embodiments, each of the apertures 253 may be an oblong slot. In some embodiments, the main plate 252 comprises four apertures 253, each aperture 253 configured to receive a respective end of a U-bolt fastener 260.

As shown in FIGS. 4A-4B (see also FIG. 3C), in some embodiments, each side wall 254 of the mounting bracket 250 comprises a recess 255. In some embodiments, each recess 255 is sized and configured to receive an outer diameter of the horizontal member 222. The recesses 255 provided a larger contact area with the horizontal member 222 to provide a more secure engagement between the mounting bracket 250 and the horizontal member 222. In some embodiments, the mounting bracket 250 may be secured to the horizontal member 222 in the respective recesses 255 (e.g., via welding).

FIGS. 5A-5C illustrate the spacing of the mounting brackets 250₁₋₅ (and respective vertical members 24 and corresponding antennas 50) for optimal antenna performance. FIG. 5A illustrates spacing for a mast and bracket support 200′ having three mounting brackets 250₁₋₃. As shown in FIG. 5A, one of the mounting brackets 250₂ is secured at a center point CP along the length L of the horizontal member 222 and the other two mounting brackets 250₁, 250₃ are secured a distance D1 from the center point CP of the horizontal member 222. In some embodiments, the mounting brackets 250₁, 250₃ are secured to the horizontal member 222 a distance D1 of about 60 inches from the center point CP.

FIG. 5B illustrates spacing for a mast and bracket support 200 having four mounting brackets 250₁₋₄. As shown in FIG. 5B, two of the mounting brackets 250₂, 250₃ are secured a distance D2 from the center point CP of the horizontal member 222 and the other two mounting brackets 250₁, 250₄ are secured a distance D3 from the center point CP of the horizontal member 222. In some embodiments, the mounting brackets 250₂, 250₃ are secured to the horizontal member 222 a distance D2 of about 24 inches from the center point CP. In some embodiments, the mounting brackets 250₁, 250₄ are secured to the horizontal member 222 a distance D3 of about 72 inches from the center point CP.

FIG. 5C illustrates spacing for a mast and bracket support 200″ having five mounting brackets 250₁₋₅. As shown in FIG. 5B, one of the mounting bracket 250₂ is secured at the center point CP of the horizontal member 222. Two of the mounting brackets 250₂, 250₄ are secured a distance D4 from the center point CP of the horizontal member 222 and the other two mounting brackets 250₁, 250₅ are secured a distance D5 from the center point CP of the horizontal member 222. In some embodiments, the mounting brackets 250₂, 250₄ are secured to the horizontal member 222 a distance D4 of about 28 inches from the center point CP. In some embodiments, the mounting brackets 250₁, 250₅ are secured to the horizontal member 222 a distance D5 of about 84 inches from the center point CP.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

What is claimed is:

1. A sector frame antenna mount assembly, the assembly comprising:
a mast and bracket support, the mast and bracket support comprising a horizontal member and a plurality of mounting brackets secured along a length of the horizontal member; and
a plurality of vertical members, each vertical member secured to a respective mounting bracket of the mast and bracket support and configured to have at least one antenna mounted thereon,
wherein the plurality of mounting brackets provide fixed mounting locations along a length of the horizontal member for the corresponding vertical members such that optimal antenna performance may be achieved when antennas are mounted to each vertical member.

2. The assembly according to claim 1, wherein the mast and bracket support comprises a first mounting bracket, a second mounting bracket, and a third mounting bracket, wherein the first mounting bracket is positioned at a center point along the length of the horizontal member, and wherein the second and third mounting brackets are positioned a distance in opposite directions from the center point.

3. The assembly according to claim 2, wherein the distance that the second and third mounting brackets are positioned from the center point is about 60 inches.

4. The assembly according to claim 1, wherein the mast and bracket support comprises a first mounting bracket, a second mounting bracket, a third mounting bracket, and a fourth mounting bracket, wherein the first and second mounting brackets are positioned a first distance in opposite directions from a center point along the length of the horizontal member, and wherein the third and fourth mounting brackets are positioned a second distance in opposite directions from the center point.

5. The assembly according to claim 4, wherein the first distance that the first and second mounting brackets are positioned from the center point is about 24 inches, and wherein the second distance that the third and fourth mounting brackets are positioned from the center point is about 72 inches.

6. The assembly according to claim 1, wherein the mast and bracket support comprises a first mounting bracket, a second mounting bracket, a third mounting bracket, a fourth mounting bracket, and a fifth mounting bracket, wherein the first mounting bracket is positioned at a center point along the length of the horizontal member, wherein the second and third mounting brackets are positioned a first distance in opposite directions from the center point, and wherein the fourth and fifth mounting brackets are positioned a second distance in opposite directions from the center point.

7. The assembly according to claim 6, wherein the first distance that the second and third mounting brackets are positioned from the center point is about 28 inches, and wherein the second distance that the fourth and fifth mounting brackets are positioned from the center point is about 84 inches.

8. The assembly according to claim 1, wherein each mounting bracket comprises a main plate having opposing side walls extending outwardly therefrom, each side wall comprises a recess sized and configured to receive a portion of the horizontal member.

9. The assembly according to claim 8, wherein the main plate of the mounting bracket includes a plurality of apertures configured to receive a fastener to secure a respective vertical member to the mounting bracket.

10. The assembly according to claim 9, wherein the main plate comprises four apertures, each aperture configured to receive a respective end of a U-bolt fastener.

11. The assembly according to claim 1, wherein each mounting bracket is welded to the horizontal member in a fixed position.

12. A sector frame antenna mount assembly, the assembly comprising:
a mast and bracket support, the mast and bracket support comprising:
a horizontal member;
a first mounting bracket;
a second mounting bracket; and
a third mounting bracket,
wherein the first, second, and third mounting brackets are secured along a length of the horizontal member; and
three vertical members, each vertical member being secured to a respective mounting bracket and configured to have at least one antenna mounted thereon,
wherein the first mounting bracket is positioned at a center point along the length of the horizontal member, and wherein the second and third mounting brackets are positioned a distance in opposite directions from the center point, and
wherein the distance that the second and third mounting brackets are positioned from the center point is about 60 inches.

13. The assembly according to claim 12, wherein each mounting bracket comprises a main plate having opposing side walls extending outwardly therefrom, each side wall comprises a recess sized and configured to receive a portion of the horizontal member, and wherein the main plate of the mounting bracket includes a plurality of apertures configured to receive a fastener to secure a respective vertical member to the mounting bracket.

14. The assembly according to claim 13, wherein the main plate comprises four apertures, each aperture configured to receive a respective end of a U-bolt fastener.

15. The assembly according to claim 12, wherein each mounting bracket is welded to the horizontal member in a fixed position.

16. A sector frame antenna mount assembly, the assembly comprising:
a mast and bracket support, the mast and bracket support comprising:
a horizontal member;
a first mounting bracket;
a second mounting bracket;
a third mounting bracket; and
a fourth mounting bracket,
wherein the first, second, third, and fourth mounting brackets are secured along a length of the horizontal member; and
four vertical members, each vertical member being secured to a respective mounting bracket and configured to have at least one antenna mounted thereon,
wherein the first and second mounting brackets are positioned a first distance in opposite directions from a center point along the length of the horizontal member, and wherein the third and fourth mounting brackets are positioned a second distance in opposite directions from the center point, and
wherein the first distance that the first and second mounting brackets are positioned from the center point is about 24 inches, and wherein the second distance that the third and fourth mounting brackets are positioned from the center point is about 72 inches.

17. The assembly according to claim 16, wherein each mounting bracket comprises a main plate having opposing side walls extending outwardly therefrom, each side wall comprises a recess sized and configured to receive a portion of the horizontal member, and wherein the main plate of the mounting bracket includes a plurality of apertures configured to receive a fastener to secure a respective vertical member to the mounting bracket.

18. The assembly according to claim 17, wherein the main plate comprises four apertures, each aperture configured to receive a respective end of a U-bolt fastener.

19. The assembly according to claim 16, wherein each mounting bracket is welded to the horizontal member in a fixed position.

20. A sector frame antenna mount assembly, the assembly comprising:
a mast and bracket support, the mast and bracket support comprising:
a horizontal member;
a first mounting bracket;
a second mounting bracket;
a third mounting bracket;
a fourth mounting bracket; and
a fifth mounting bracket,
wherein the first, second, third, fourth, and fifth mounting brackets are secured along a length of the horizontal member; and
five vertical members, each vertical member being secured to a respective mounting bracket and configured to have at least one antenna mounted thereon
wherein the first mounting bracket is positioned at a center point along the length of the horizontal member, wherein the second and third mounting brackets are positioned a first distance in opposite directions from the center point, and wherein the fourth and fifth mounting brackets are positioned a second distance in opposite directions from the center point, and
wherein the first distance that the second and third mounting brackets are positioned from the center point is about 28 inches, and wherein the second distance that the fourth and fifth mounting brackets are positioned from the center point is about 84 inches.
